(19) United States
(12) Patent Application Publication
(10) Pub. No.: US 2026/0297280 A1
(43) Pub. Date: Oct. 1, 2026

(54) MATTRESS ASSEMBLIES INCLUDING ZONED FIRMNESS OPTIMIZATION BY POLYMER IMPREGNATION OF A FOAM LAYER

(71) Applicant: SERTA SIMMONS BEDDING, LLC, Doraville, GA (US)

(72) Inventor: Victor Prince, Chamblee, GA (US)

(21) Appl. No.: 19/636,287

(22) Filed: Apr. 1, 2026

Related U.S. Application Data
(60) Provisional application No. 63/781,660, filed on Apr. 1, 2025.

(51) Int. Cl. C08J 9/42

(52) U.S. Cl. CPC C08J 9/42; C08J 2375/04

(57) ABSTRACT

Mattress assemblies including a foam layer comprising at least one porous surface, the at least one porous surface comprising targeted portions thereof including a cured polymer impregnated into pores of the at least one porous surface, wherein the cured polymer alters a firmness dimension of the foam layer relative to non-target portions without the cured polymer.

### CROSS REFERENCE TO RELATED APPLICATION

The present application claims the benefit of priority to U.S. Application No. 63/781,660, filed Apr. 1, 2025, the content of which is incorporated by reference in its entirety herein.

### BACKGROUND

The present disclosure generally relates to mattress assemblies; and more particularly, to zoned firmness optimization by polymer impregnation of a foam layer utilized in the mattress assembly.

Zoned mattress assemblies are generally designed to optimize comfort, support, and spinal alignment by incorporating different firmness levels in specific areas of the mattress. Firmness here refers to the amount of force required to deflect the foam—referred to commonly in the furniture industry either as ILD (Load Deflection) or IFD (Force Deflection), depending on the method of firmness. Firmness is generally correlated to support, used to calculate a ratio called Support Factor referring to how firm a foam is at relative compressions.

Methods do exist for creating a single layer using vertical lamination of various foams of different firmness ratings, since this can be a desirable configuration in applications that require supporting different areas of the body. These manufacturing methods are involved, expensive, and not commonly used, but the results are very effective as measured by typical industry testing. Zoned support can be achieved using different materials and technologies. In all-foam mattresses, zoning is often implemented through variations in foam density, laser-cut channeling, or convoluted foam patterns that adjust firmness in specific regions. Some models use differential indentation load deflection (ILD) ratings, where softer foams are placed at the shoulders and firmer foams in the lumbar zone. Hybrid constructions, which combine foam layers with zoned pocketed coil systems, enhance support by using coils of different thicknesses or tensions. These hybrid designs allow for deep compression support while maintaining responsiveness and breathability.

Drawbacks of these fabrication methods include but are not limited to: fabrication challenges; lack of isotropy in raw materials resulting in unpredictable final firmness; increased inventory due to requirements to stock various part numbers required to produce these layers; and the like.

One common construction of a zoned mattress includes a three-zone design, which typically features a firmer lumbar section to support the lower back while the shoulder and leg areas are softer for enhanced pressure relief. This simple yet effective approach is widely used in both all-foam and hybrid mattresses. A more advanced five-zone system further refines the zoning by incorporating additional support areas for the knees and upper back, balancing pressure relief and spinal support even more precisely, which is shown in prior art FIG. 1. More specifically, a five-zone system might include a head and shoulder region 102, an upper body region 104, a spine region 106, a lower body region 108, and a lower leg region 110. For sleepers requiring the highest level of contouring, a seven-zone construction (not separately shown) divides the mattress into even more finely tuned regions, with alternating firm and soft sections that cradle the body's curves and reduce tension in key pressure points.

Ultimately, zoned mattress assemblies cater to various sleep preferences and body types by ensuring balanced support and pressure relief. Whether constructed from memory foam, latex, or hybrid materials, these specialized designs help improve sleep posture and alleviate discomfort, making them a popular choice for those seeking enhanced ergonomic benefits in their mattress.

### BRIEF SUMMARY

Disclosed herein are mattress assemblies including zoned firmness optimization by polymer impregnation of a foam layer utilized in the mattress assembly to target specific support areas of the mattress assembly.

The disclosure may be understood more readily by reference to the following detailed description and drawings of the various features of the disclosure and the examples included therein.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 schematically illustrates a cross-sectional view of a five-zone mattress assembly including a foam layer configured with different firmness's to support different areas of a prone end user;

FIG. 2 illustrates a process flow for impregnating a foam layer with a polymer to selectively alter the firmness properties of the foam layer in accordance with one or more embodiments of the present disclosure;

FIGS. 3a-c schematically illustrate cross-sectional views of two mattress assemblies without zoned impregnation having foam layers with different firmness levels and a mattress assembly including zoned polymer impregnation at specific target areas of a foam layer, respectively, in accordance with one or more embodiments of the present disclosure; and

FIG. 4 illustrates a process in accordance with one or more embodiments of the present disclosure.

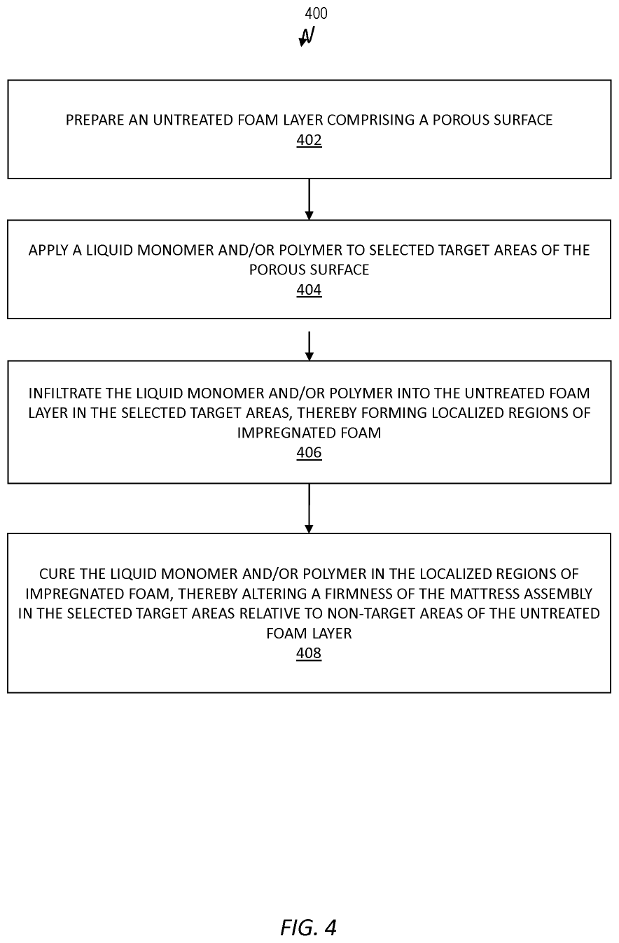

### DETAILED DESCRIPTION

Disclosed herein are mattress assemblies including zoned firmness optimization by polymer impregnation of selected areas of a foam layer utilized in the mattress assembly to increase firmness. Polymer impregnation can be applied to specific targeted areas to minimize pressure points associated with a prone user of the mattress assembly and provide balanced support and pressure relief.

Polymer impregnation, also known as polymer infiltration or polymerization, is a process where a polymer in liquid form, of some viscosity, is introduced into a porous material, such as foam, to enhance its firmness properties. This process can be used to create composite materials that leverage the advantages of both the polymer and the base material (e.g., foam).

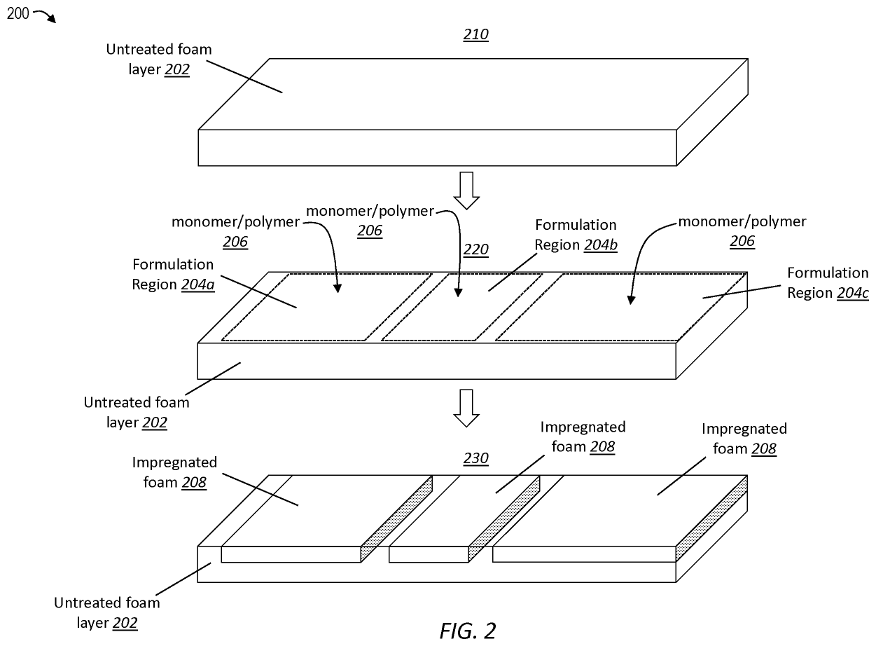

Referring now to FIG. 2, there is illustrated a process flow 200 for impregnating selected areas of a foam layer (e.g., polyurethan foam). In step 210, an untreated foam layer 202 is prepared for impregnation, which usually involves cleaning a selected surface to remove any contaminants or impurities from the surface that could hinder the impregnation of the polymer. Optionally, the foam layer 202 can be preheated or preconditioned to improve the permeability of the material. Permeability is a factor of many characteristics of the foam layer 202 including but not limited to foam density, foam porosity, surface characteristics like texture.

The foam layer 202 may be formed from (but is not limited to) polyethylene, latex, polyurethane, polystyrene, ethylene vinyl acetate (EVA) or other foam material commonly known and used in the bedding and seating arts. The foam layer 202 can be open-cell or closed-cell structures or reticulated structures, which allow for polymer penetration at different depths with varying degrees of efficacy.

The various foams suitable for use in the foam layer 202 may be produced according to methods known to persons ordinarily skilled in the art. For example, polyurethane foams are typically prepared by reacting a polyol with a polyisocyanate in the presence of a catalyst, a blowing agent, one or more foam stabilizers or surfactants and other foaming aids. The gas generated during polymerization causes foaming of the reaction mixture to form a cellular or foam structure. Latex foams are typically manufactured by the well-known Dunlap or Talalay processes. Manufacturing of the different foams are well within the skill of those in the art.

The foam layer 202 can include one or more separate foam layers (not separately indicated). The different properties for each layer defining the foam layer 202 may include, but are not limited to, density, hardness, thickness, support factor, flex fatigue, air flow, glass transition temperature, various combinations thereof, and the like. Density is a measurement of the mass per unit volume and is commonly expressed in pounds per cubic foot. By way of example, the density of the each of the foam layers can vary. In still other embodiments, one or more of the foam layers can have a convoluted surface. The convolution may be formed of one or more individual layers with the foam layer 202. The firmness of hardness properties of the foam are also referred to as the indention load deflection (ILD) or indention force deflection (IFD) and is measured in accordance with ASTM D-3574. Like the density property, the hardness properties can be varied in a similar manner. Moreover, combinations of properties may be varied for each individual layer. The individual layers can also be of the same thickness or may have different thicknesses as may be desired to provide different tactile responses.

The hardness of the untreated foam layer 202 generally has an indention load deflection (ILD) of 7 to 16 pounds×force for viscoelastic foams and an ILD of 7 to 45 pounds×force for non-viscoelastic foams. ILD can be measured in accordance with ASTM D 3574. The density of the layers can generally range from about 1 to 2.5 pounds per cubic foot for non-viscoelastic foams and 1.5 to 6 pounds per cubic foot for viscoelastic foams.

In step 220, target areas, or formulation regions 204 (or as more specifically shown in FIG. 2, formulation regions 204a, 204b, and 204c), of a selected surface(s) of the foam layer 202 are coated with a monomer and/or polymer 206. One or more surfaces can be coated with the monomer/polymer 206. The selected surfaces can be oriented to be facing towards the end user when in use or facing away, as desired. The target areas are associated with region or regions of the untreated foam surface 202 to strategically alter firmness of those regions. It should be understood that the specific formulation regions 204a, 204b, and 204c shown in FIG. 2 are only illustrative. Any number of formulation regions 204 having any desired dimensionality (e.g., width, height, and/or depth along the foam layer 202) can be similarly formed via treatment of the foam layer 202 at the desired regions, and all such configurations are within the contemplated scope of this disclosure.

The monomers and/or polymers are not intended to be limited and will generally depend on the desired firmness properties. The monomers and/or polymers are formulated with a suitable additive to provide effective curing and the desired polymer properties within the pores of the foam layer 202. The monomer formulations can include thermal or photoinitiators to effect polymerization. The polymer formulations can include crosslinkers or the like. By way of example, the monomers and/or polymers can be used to provide epoxy resins, which are known to provide excellent adhesive properties and high mechanical strength. Epoxy resins can be suitable for foams needing structural reinforcement. Other polymers formed within the pores include, without limitation, polyurethane, which offers flexibility and impact resistance; polyvinyl acetate (PVA), which can be used for more rigid and stable foams; phenolic resins, which are good for high-temperature applications; silicones which can be used for applications requiring flexibility and high-temperature stability; polyethylene (PE); polystyrene (PS); as well as other thermoplastics: These polymers are sometimes used as blends to achieve specific mechanical or thermal properties.

The monomer and/or polymer formulations are typically in a liquid form before they are introduced into the foam layer 202. The monomer and/or polymer 206 is then allowed to infiltrate into the foam layer 202, resulting in localized region(s) of impregnated foam 208. There are a few common methods for infiltrating a foam surface with a polymer. By way of example, vacuum infiltration can be used, wherein a vacuum chamber is used to remove air from the foam and create negative pressure. This allows the polymer to be drawn into the foam's pores, ensuring complete infiltration. After the vacuum step, the chamber is returned to normal pressure, and the polymer is allowed to solidify, often by curing with heat or chemical reaction. Other methods include pressure infiltration, which involves applying pressure to force the liquid polymer into the foam structure. This process can be used for larger volumes of foam or when deeper penetration of the polymer is required. Still other methods include capillary action, wherein the liquid monomer and/or polymer formulation is drawn into the foam without applying external pressure or vacuum. This method is more passive but may not be effective for all foam types.

In step 230, the monomers/polymers 206 are cured. Curing can include thermal curing, chemical curing, photocuring or the like. In thermal curing, heat is applied to the impregnated foam 208 to activate the polymer's curing process (e.g., with epoxy or polyurethane), which can effect polymerization and/or polymeric crosslinking. Chemical curing includes adding a hardener or curing agent to the formulation that triggers a chemical reaction at room temperature or elevated temperatures. Photocuring includes exposure of a photoinitiator in the formulation to activating radiation such as ultraviolet light or the like to effect polymerization.

After the polymer has cured, the impregnated foam 208 and/or untreated foam layer 202 may need to undergo further processing such as trimming, finishing, or additional surface treatments, depending on the intended use of the composite material.

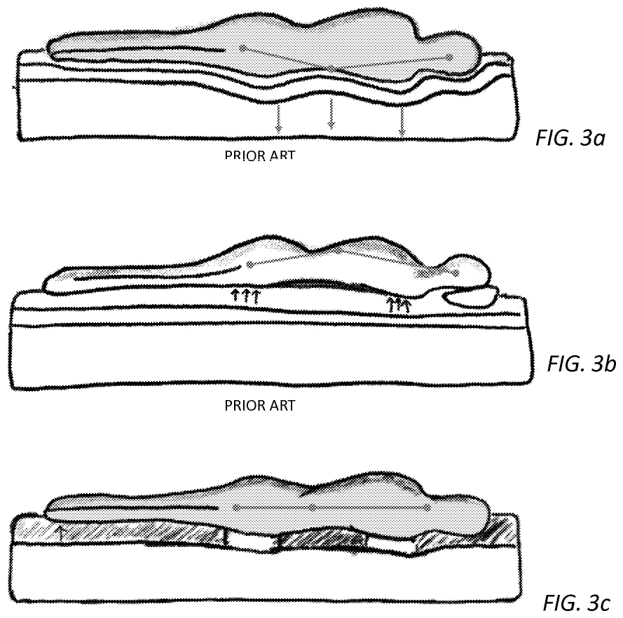

FIGS. 3A-C illustrate cross-sectional views of two mattress assemblies without zoned impregnation having foam layers with different firmness levels (refer to FIGS. 3a and 3b) and a mattress assembly including zoned polymer impregnation at specific target areas of a foam layer (refer to FIG. 3c), respectively, in accordance with one or more embodiments of the present disclosure.

FIG. 3A illustrates a mattress assembly including multiple relatively soft foam layers in a stacked arrangement. None of the foam layers include zoned impregnation optimization with a monomer and/or polymer. As shown, the presence of soft foam layers results in compression from the prone end user that generally correlates to greater compression of those body portions that weight the heaviest, which creates sub-optimal support as evidenced by the arrows depicting pressure point areas formed as a result of the foam being too soft and inadequate to provide sufficient support. The shoulder, back and buttock regions are lower relative to the head and leg regions.

In FIG. 3B, the converse is depicted with a mattress assembly including multiple relatively firm foam layers in a stacked arrangement. None of the foam layers include zoned impregnation optimization with a monomer and/or polymer. As shown, the presence of much firmer foam layers results in less compression such that shoulder, back and buttock regions are raised relative to the head and leg regions. The heavier regions are not able to fully compress the foam layer, resulting in areas of bridging and spinal misalignment

FIG. 3C illustrates a mattress assembly including zone impregnation from the prone end user of a single foam layer for improved contouring and support. The zone impregnation of selected area can provide pressure relief in targeted ways, which other areas are supported more effectively, resulting in improved spinal alignment.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### Additional Context

Layers of polyurethane foam as are used in typical mattresses are typically limited to a single firmness profile. Firmness here refers to the amount of force required to deflect the foam—referred to commonly in the furniture industry either as ILD (Load Deflection) or IFD (Force Deflection), depending on the method of firmness. Firmness is generally correlated to support, used to calculate a ratio called Support Factor referring to how firm a foam is at relative compressions.

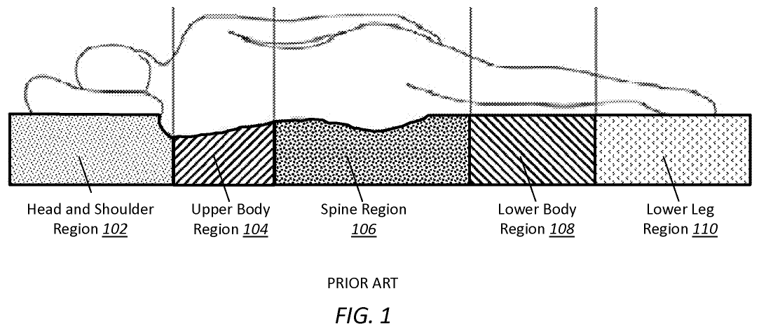

For example, a 2″ thick layer of foam of a firmness, (A), would not be able to provide different levels of firmness along its length or width. Methods exist for creating a single layer using vertical lamination of various foams of different firmness ratings, since this is a desirable configuration in applications that require supporting different areas of the body. These manufacturing methods are involved, expensive, and not commonly used, but the results are very effective as measured by typical industry testing (FIG. 1). Serta Simmons Bedding has pending IP around application of these techniques to drastically improve spinal alignment. Drawbacks of this fabrication method include but are not limited to: fabrication challenges; lack of isotropy in raw materials resulting in unpredictable final firmness; increased inventory due to requirements to stock various part numbers required to produce these layers. Methods of attempting to surface coat a foam to firm or change the performance of certain areas have limited effect because they do not sufficiently alter the firmness of the foam layer. Because of the drawbacks to these methods, the industry typically relies on layered foams of various thicknesses that compress to various degrees beneath different areas of the body as shown in FIG. 2. These builds are much less effective in providing the desired “zoned” support than truly zoned material layers. Because of these challenges, alternative methods for creating a single-layer zoned are desirable.

This disclosure proposes using a method of polymer surface impregnation to locally stiffen a layer of foam of a specified width, length, and depth to zone the layer without using the existing processes, specifically for use as a comfort layer in a mattress.

By taking a layer of polyurethane foam of a specified width, length, and thickness and applying a polymer impregnation process to the surface of the foam in specific areas, it is possible to create zoned areas of various firmness ratings in a single layer foam. Using proper viscosity, application weight, and specifically tuned processes, the depth, intensity, and area effected by the impregnation can be finely controlled. This process results in a single layer of supportive polyurethane foam that has various zoned firmness ratings designed to adjust the layer to support much more effectively.

Starting from a layer of polyurethane foam of a specified density, firmness, thickness, width, and length, a single area or multiple areas of the foam are treated with a polymer-based impregnant in liquid form that, once applied, will solidify and modify the foam properties in that area. The polymer application can be done with various formulations, and can be impregnated to various depths, to achieve the desired change in firmness in the treated area. The resulting physical properties are a direct result of the above application variations.

Using established techniques of polyurethane foam post-processing, including surface treatment of chemistries and intentional depth-impregnation, this invention would functionalize a polyurethane foam layer to provide customized, zoned comfort as defined by specified Indentation Load Deflection (ILD) and/or Indentation Force Deflection (IFD) and proprietary testing methods that govern industry-secrets around idealized body support.

Impregnation of polyurethane foam materials is a well-established technique for creating novel materials by changing the properties of the carrier polyurethane. Industries such as filtration, insulation, and seals all use forms of impregnated polyurethanes to combine the features and benefits of the polyurethane foam with those of the impregnant. This filing is a utilization of that same concept applied to specific design targeting ergonomic support.

Solving this problem with existing impregnation technology is the root of this invention. There are existing techniques for foam impregnation, and some of them are now used for surface treatments like phase-change coatings. By developing the proper chemistries to apply across a range of foam densities and porosities, a range of firmness can be achieved with a relatively narrow combination of materials. Furthermore, by developing application techniques to target areas on a foam topper, we can create customization techniques to further increase our unique offerings, again while limiting the required inventory to do so.

Important aspects of this invention are the implementation of the foam coating and impregnation in conjunction with internally developed expertise around optimization of spinal alignment and sleep surface conformance. Relevant work to reference includes proprietary spinal alignment measurement techniques, research on body types, weight distributions, and general anatomy as it relates to sleep comfort.

What is claimed is:

1. A method of forming a mattress assembly having zoned firmness, the method comprising:
preparing an untreated foam layer comprising a porous surface;
applying a liquid monomer and/or polymer to selected target areas of the porous surface;
infiltrating the liquid monomer and/or polymer into the untreated foam layer in the selected target areas, thereby forming localized regions of impregnated foam; and
curing the liquid monomer and/or polymer in the localized regions of impregnated foam, thereby altering a firmness of the mattress assembly in the selected target areas relative to non-target areas of the untreated foam layer.

2. The method of claim 1, wherein preparing the untreated foam layer comprises cleaning the porous surface to remove contaminants or impurities that could hinder impregnation of the liquid monomer and/or polymer.

3. The method of claim 1, wherein applying the liquid monomer and/or polymer to the selected target areas comprises coating the one or more selected surfaces of the untreated foam layer with the liquid monomer and/or polymer at formulation regions corresponding to the selected target areas.

4. The method of claim 3, wherein coating the one or more selected surfaces comprises applying the liquid monomer and/or polymer in a controlled amount effective to infiltrate pores of the untreated foam layer within the formulation regions.

5. The method of claim 1, wherein infiltrating the liquid monomer and/or polymer into the untreated foam layer comprises subjecting the untreated foam layer to vacuum infiltration to remove air from the untreated foam layer and draw the liquid monomer and/or polymer into pores of the untreated foam layer in the selected target areas.

6. The method of claim 1, wherein curing the liquid monomer and/or polymer comprises applying heat to the localized regions of impregnated foam to activate polymerization and/or polymeric crosslinking of the liquid monomer and/or polymer.

7. The method of claim 1, wherein the untreated foam layer comprises a foam material selected from the group consisting of polyethylene, latex, polyurethane, polystyrene, and ethylene vinyl acetate.

8. The method of claim 1, wherein the liquid monomer and/or polymer comprises a liquid monomer comprising a monomer formulation including a thermal initiator or a photoinitiator.

9. The method of claim 1, wherein the liquid monomer and/or polymer comprises a liquid polymer comprising a polymer material selected from the group consisting of epoxy resin, polyurethane, polyvinyl acetate, phenolic resin, silicone, polyethylene, and polystyrene.

10. A mattress assembly comprising:
a foam layer comprising at least one porous surface, the at least one porous surface comprising targeted portions thereof including a cured polymer impregnated into pores of the at least one porous surface, wherein the cured polymer alters a firmness dimension of the foam layer relative to non-target portions without the cured polymer.
